(19) United States
(12) Patent Application Publication
(10) Pub. No.: US 2018/0121782 A1
(43) Pub. Date: May 3, 2018

(54) COUNTING STACKED PLANAR SUBSTRATES

(71) Applicant: DAS-NANO, S.L., TAJONAR (ES)

(72) Inventors: Guillermo BARBADILLO VILLANUEVA, TAJONAR (ES); Eduardo AZANZA LADRÓN, TANJONAR (ES); Magdalena CHUDZIK, TAJONAR (ES); Mikel SUBIZA GARCÍA, TAJONAR (ES); Alex LÓPEZ ZORZANO, TAJONAR (ES); Daniel ZABALA RAZQUIN, TAJONAR (ES)

(21) Appl. No.: 15/567,946

(22) PCT Filed: Apr. 21, 2015
(86) PCT No.: PCT/EP2015/058573

§ 371 Date: Oct. 19, 2017

(51) Int. Cl. G06M 1/10; G06M 9/00; H04N 1/00

(52) U.S. Cl. CPC G06M 1/101; H04N 1/00702; H04N 1/00734; G06M 9/00

(57) ABSTRACT

Devices and methods for counting planar substrates stacked on a first plane are disclosed. Image capturing sensors are arranged collinearly in a manner substantially perpendicular to the first plane. The image capturing sensors are configured to capture images of portions of counting sides of the stacked planar substrates. The image capturing sensors are configured so that the images captured by every two consecutive image capturing sensors comprise an overlapping portion of the stacked planar substrates.

The present disclosure refers to counting and more specifically to counting of stacked planar objects.

### BACKGROUND

Planar substrates, e.g. security documents such as bank notes or playing cards, are often stacked in packets for transportation or handling. In various occasions, e.g. before they change owner, they need to be precisely counted. There are two types of apparatus for counting: mechanical and optical.

Mechanical counting apparatus may damage the substrates, especially paper, plastic, polymer or hybrid substrates such as banknotes, because contact is needed for counting. This damage may limit the number of counting processes that can be done to the same substrate. The more the counts the bigger the damage to the substrate, and a damaged paper stack cannot be thereafter used and/or counted by a mechanical counting apparatus. Furthermore, mechanical counting apparatus are slow. Typically counting a stack of 500 sheets may take around 15-20 seconds.

Some security features of the substrates, such as metallic foils may end up wearing the discs of the mechanical counting apparatus making them less precise and prone to failure and requiring frequent maintenance.

Some substrates, such as polymer or hybrid paper and polymer substrates, are difficult to count with mechanical methods, as they tend to stick together. Other multilayer substrates such as glued paper and stickers are also difficult to count with mechanical methods as the mechanical disks may split each layer, thus destroying the material.

Traditional optical counting apparatus have the advantage that the counting may be contactless with no damage done to the substrates. However, the thickness of the stacked objects has to be similar to cards, e.g. playing cards and cannot measure objects as thin as paper. Furthermore, they are also slow because they have a single camera that moves to scan the whole stack.

There is a need for a device and method of counting planar substrates to solve the above-mentioned problems.

### SUMMARY OF THE INVENTION

In a first aspect a device for counting planar substrates stacked on a first plane is disclosed. The device comprises image capturing sensors arranged collinearly, substantially perpendicularly to the first plane. Each image capturing sensor is configured to capture an image of a portion of a counting side of the stacked planar substrates. The image capturing sensors are configured so that the images captured by every two consecutive image capturing sensors comprise an overlapping portion of the stacked planar substrates.

By capturing multiple images of portions of the substrates it is possible to identify individual substrates in the captured images. The images captured with the image capturing sensors need to cover the entire area of interest, which contains the information necessary to apply any counting algorithms. Thus, between the images, a minimum overlap section is required, which needs to coincide with the focused part of the image. The overlapping portions allows for accurate combining of the images so that no substrate is counted twice.

The proposed device may be fast because the image capturing sensors don't move and the processing time of the images may be very short. Because the process is contactless, no damage may also be done to the substrates.

In some examples, the image capturing sensors may be arranged along a frame. The frame may be arranged perpendicularly to the first plane. Therefore, the distance between the sensors and the stacked planar substrates may remain constant.

In some examples each image capturing sensor may be arranged on a frame. The frames may be arranged consecutively perpendicularly to the first plane. This allows for easy replacement of each sensor, as only the corresponding frame may need to be removed from the device.

In some examples each image capturing sensor may be arranged opposite to and facing the portion of the counting side of the stacked planar substrates along a line perpendicular to the counting side of the stacked planar substrates. This allows for counting the substrates along the shortest distance between the top and bottom substrates of the stack.

In some examples, the image capturing sensors may be arranged collinearly in two or more columns. Each column may be configured to capture images along different sections of the stacked planar substrates. The counting may then be implemented for each set of images for each column. By comparing the results it may be possible to increase the accuracy and reliability of the counting process and/or identify errors in the placing or in the counting.

In some examples the image capturing sensors may be arranged in an array having columns and rows. The image capturing sensors may be configured to capture images of overlapping portions of the stacked planar substrates opposite the columns and rows of the array. Multiple composite images may thus be generated by the various columns of image capturing sensors or a single composite extended image covering an expanded area of the counting side of the stack of planar substrates.

In some examples, each image capturing sensor may comprise one or more lens elements and an electronic sensor, wherein the one or more lens elements are configured to capture the light from the portion of the counting side of the stacked planar substrates and bring it to a focus on the electronic sensor. It is noted that the image captured by the one or more lens elements of each image capturing sensor needs to be wider than the distance between the centers of two consecutive sensors. Thereby, images with overlapping portions may then be captured.

A working distance may be defined as a distance between the lens elements and the edge of the stacked substrates and it may be related with the focusing properties of the optical components and the level of detail or resolution, of the captured image. The maximum working distance may be selected in order to attain the detail level required to distinguish between consecutive pieces of stacked substrates. The maximum working distance may depend on the specifications of the optical components used (such as focal distance and optical quality of the lens elements) as well as on the specifications of the optical sensor used (such as the size and resolution of the sensor) and may be selected depending on the minimum thickness of the substrates to be counted or the minimum thickness of the gap formed between said substrates. Thus, the minimum overlap section between the images may be equal to the thickness of the single analyzed substrate (taking into account that the image of the boundary sheet may correspond with the focused areas of both images). The working distance that may fulfill the given requirements for the focusing properties of the optical components may need to be specified. In some cases, the optimum conditions for the working distance may be achieved by choosing the focal distance of the camera lens and the distance between the lens and the sensor used.

In some examples, each image capturing sensor may further comprise multiple lens elements, arranged consecutively one after the other, and configured to modify the focal distance of the image capturing sensor to define the overlapping portion of two images captured by two consecutive image capturing sensors and to allow identification of individual substrates of the stack. Therefore, the optical properties of the sensor may be modified by using additional external lenses that change the focal distance of the optical system. As a result, the device may measure very thin objects. The modified optical properties of the image capturing sensors may allow the system to capture images having a number of pixels that may be correspond to the thickness of each substrate or to the space between any two substrates.

In some examples the device may further comprise one or more marking elements, configured to indicate the overlapping portion on the captured images. In some implementations, the marking elements may be laser light sources. They may emit or project light beams to indicate a reference point or pattern in the overlapping portion on the captured images. The laser light sources may comprise a controller, optical or electronic, to modify the size of a spot of the light beams. Each laser light source may be configured so that the spot of the light beam is pointing at a planar substrate positioned substantially on a plane perpendicular to a connecting edge between two consecutive image capturing sensors. Due to the limited size of the overlapping portion and similarity of the captured images, additional externally generated patterns may be used in order to simplify the detection of the image features, i.e. the individual substrates. The selected marker or pattern may be projected by the laser source directly on the edges of the stack in order to avoid distortion and perspective errors in the images captured with two optical sensors. The obtained marker may illuminate the piece of substrate that can be viewed from both cameras. The coordinates of the laser point-marker may be used to mark the limits of each image and, finally, to combine the adjacent images. The lasers may be situated on the side of the optical sensors. The spot generated by each laser may be projected on the edge of the stack in the area found in the middle of the distance between two optical sensors. In some cases, the optics of the laser may be modified in order to limit the dimensions of the laser spot in order to obtain a size comparable with the thickness of the analyzed substrates. The optical properties may be modified by using external lenses, for which the focal length may be selected taking into account the working distance of the optical sensors and the fact that the laser housing should not enter in the field of view of interest the optical sensors.

The laser spot may be detected on each image using algorithms based on color detection or pattern detection. The position of the laser spot may be detected in both adjacent images in order to limit the areas of each image, where the counting algorithm is to be applied and, in some cases, to combine the images and apply the counting algorithm to the final output image.

In some examples the device may further comprise a protective transparent element, arranged in front of the image capturing sensors. If the sensors are arranged along a second plane, perpendicular to the first plane, the protective transparent element may be arranged parallel to the second plane. The protective transparent flat element may protect the optical sensors and laser sources from coming in contact with the stacked substrates. In some implementations the protective transparent element may be a made of glass or polycarbonate material.

In some examples the device may further comprise a supporting casing. The supporting casing may help to define a minimum distance between the sensors and the substrates. It may also help to prevent the influence of external light on the counting process.

In some examples the supporting casing may comprise multiple sets of image capturing sensors. Each set of image capturing sensors may be configured to capture images of one pack of stacked planar substrates at different locations of the pack. This may increase the accuracy of the counting process and allow for the detection of errors, such as folded, hidden or misaligned substrates. Furthermore, it may increase the confidence of the counting process. For example, if the count of both sets may give the same number, then the result may be considered validated. Otherwise, another counting may be required after the stack is e.g. better aligned or repositioned. This may also depend on the desired accuracy of the measurement. That is, for banknotes, where an increased accuracy is presumed, it would be required that all sets give the same count. In other applications, e.g. when counting blank paper sheets, the accuracy may be sufficiently high within a range of one or two sheets per hundred sheets. Therefore, if the counts from the sets are within the range the result may be considered validated. Alternatively, each set of image capturing sensors may be configured to capture images of a different pack of stacked planar substrates, respectively.

In some examples the device may further comprise one or more light emitting modules attached to the supporting casing to illuminate the stacked planar substrates. The one or more light emitting modules may be used in order to ensure uniform illumination distribution over the entire image area. Moreover, it may be used in order to guarantee the repeatability of the image-capturing conditions.

In some examples, the one or more light emitting modules may be arranged collinearly on the supporting case. The light emitting modules may be LEDs, fluorescent lights, infrared lights or any other type of light that would be appropriate for illuminating and better defining the substrates.

In some examples, the device may further comprise an alignment detector. The alignment detector may be configured to indicate the alignment of the stacked planar substrates. In some implementations the alignment detector may be a line laser. The line laser may be arranged on the same plane as the image capturing sensors and project a line beam perpendicular to the stacked substrates. The line projected onto a side of the stack may be traced from the bottom to the top of the stack and local deviations in its trajectory may be used to calculate a depth position of each piece of substrate in order to obtain information about possible misalignment of the stack. In other implementations the depth position may be calculated with the help of additional image capturing sensors, e.g. cameras. In some cases three-dimensional (3D) image capturing modules, such as 3D or stereoscopic cameras may be used.

In some examples, the device may further comprise a moveable lid. The movable lid may be configured to press against the top substrate of the stack. The front view of the device found above the stack may be covered using the movable lid. The position of the lid may depend on the height of the stack. The moveable lid may be manually actuated or it may be motorized. By pressing against the top substrate it is possible to make the images more uniform. Furthermore, it may harmonise the background beyond the top of the substrates, so that it may not interfere with the identification and counting and limit the amount of ambient light that enters to the sensors. This may affect the quality of the image capturing the top part of the stack. It may also delimit the start of the pack, i.e. the top substrate of the pack. The interior of the lid may be colored in a manner that clearly distinguishes from the substrates. It is further noted that the device may be placed on a base that may be of a similar color so that the same principles apply to the bottom of the stack.

In some examples, the image capturing sensors may be coupled to a preprocessing module for preprocessing the captured images. Each of the image capturing sensors may be coupled to a preprocessing module, respectively, for preprocessing the captured images.

In some examples, the device may further comprise a counting processing system for receiving the preprocessed images and count the stacked planar substrates based on the preprocessed images. In some examples the preprocessing modules may be integrated in the counting processing system. The preprocessing modules may be configured to receive the images and perform image recognition algorithms to recognize each substrate of the stack.

In some examples, the counting processing system may be configured to implement counting algorithms to count the recognized substrates. The counting algorithms may be one or a combination of a binary threshold algorithm, an adaptive threshold algorithm, a linear filters algorithm, a template matching algorithm or machine learning algorithms, such as decision trees algorithms, random forest algorithms, support vector machines algorithms, neural networks algorithms, naïve bayes algorithms, nearest neighbor algorithms, clustering algorithms, or any other appropriate algorithm.

In some examples the counting processing system may be further configured to implement image combination algorithms to generate a composite image of the captured images before counting the substrates. The images obtained with the consecutive cameras may be combined using matching algorithms that detect characteristic features of each image.

In some examples the stacked planar substrates may be stacks of security documents, stacks of sheets of security documents or stacks of substrate sheets used in the production of security documents. The security documents may be e.g. paper sheets, polymer sheets, banknotes.

The planar substrates may be made of paper, plastic, polymer or be a hybrid combinations thereof. Examples of planar objects are passport sheets, identification cards, plastic cards, labels, stickers or any other thin planar object that may be stacked.

In another aspect an arrangement for counting planar substrates stacked on a first plane is disclosed. The arrangement may comprise a plurality of counting devices, as disclosed herein, arranged opposite different sections of the stacked planar substrates. In some examples the plurality of devices may be arranged at different corners of the stacked planar substrates and/or around the stacked planar substrates. The purpose of using more than one devices may be to increase the accuracy of the counting process and to identify errors, e.g. folded or misaligned substrates.

In another aspect a method of counting planar substrates stacked on a first plane is disclosed. The method comprises capturing multiple images of the stacked planar substrates along a second plane, perpendicular to the first plane. Said multiple images may contain a complete counting side of the stacked planar substrates. Each image may contain a portion of the counting side. Any two consecutive images captured may comprise an overlapping portion of the counting side of the stacked planar substrates. The method further comprises identifying the overlapping parts of the consecutive images, identifying each individual substrate and counting the identified substrates.

In some examples the identification and/or counting may be performed in the individual captured images. Then the common—overlapping-part may be identified so that the total count only accounts once for each substrate. Alternatively, the captured images may be combined to generate a composite image and the identification may be performed in the composite image. Said combining may comprise matching the overlapping portions of the consecutive images. The position of the laser spot on two adjacent images may be used to merge the images. In other cases (when the size of the laser spot coincides with more than one piece of analyzed substrates), the coordinates of the center of the laser spot may be detected on both images and may then be used to select the position of larger areas of the image, which may be utilized as template and matching areas. A template matching algorithm may be applied in order to identify the overlapping portions of the consecutive images and find the position of best correlation between the two areas. This position may be used to calculate the frontier sheet, where the counting algorithm may be applied. Otherwise the two images may be combined and the counting algorithm may be applied to the combined image.

In some examples, the method may further comprise identifying errors in the placement and/or the counting of the stack. This may be implemented during the identification stage and/or the counting stage. For example, if a substrate is identified by a number of pixels that is double the number of pixels of the rest of the substrates, this could be an indication of a folded or misaligned (protruding) substrate. Furthermore, if a substrate is hidden, i.e. misaligned because it may be retracted in the stack, then there may be a discontinuity in the image and/or the number of pixels indicating the substrate may be smaller than the number of pixels of correctly aligned substrates. In another example, if during counting one area gives less substrates than another area, this could be an indication of an error in the placement of the substrates in that area.

In some examples, identifying the substrates may comprise identifying each substrate with a certainty above a predetermined threshold. The predetermined threshold may be set according to the importance of an exact count. For example, when identifying a substrate, a minimum number of consecutive pixels may be required to identify a substrate. If all the identified substrates exceed the minimum number this may provide increased certainty. If, however, one or more areas fall below the minimum number, this may be an indication of an error and may reduce the certainty. The minimum number of pixels would then be the predetermined threshold.

In another aspect, a computing device is disclosed. The device may comprise a memory and a processor. The memory may store computer program instructions executable by the processor. Said instructions may comprise functionality to execute a method of counting planar substrates stacked on a first plane according to examples disclosed herein.

In yet another aspect a computer program product is disclosed. The computer program product may comprise instructions to provoke that a computing device implements a method of counting planar substrates stacked on a first plane according to examples disclosed herein.

### BRIEF DESCRIPTION

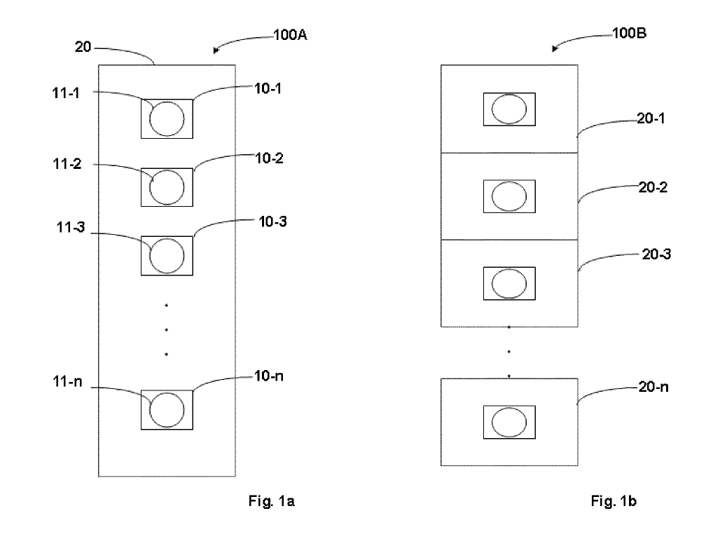

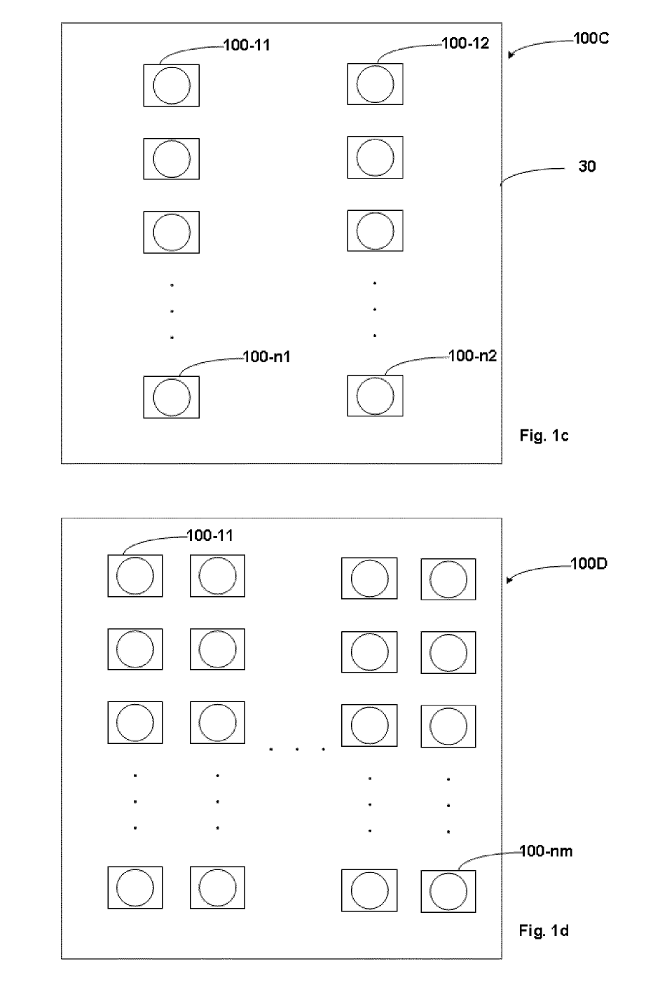

FIGS. 1a and 1b illustrate image capturing sensors arranged collinearly along the same plane, according to example implementations.

FIG. 1c, illustrates image capturing sensors arranged in parallel columns, according to an example implementation;

FIG. 1d illustrates image capturing sensors arranged in an array on the same plane, according to an example implementation;

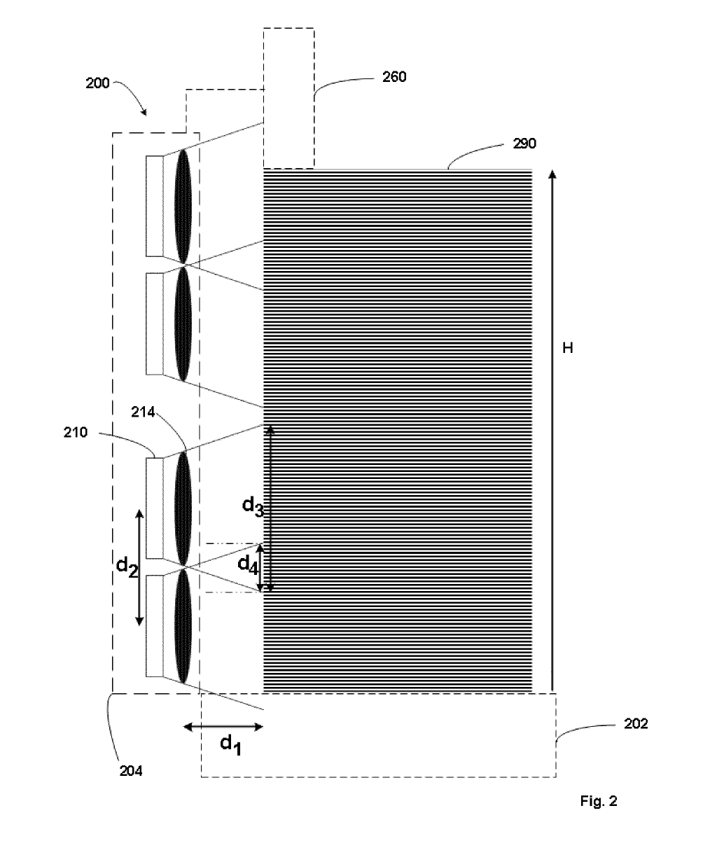

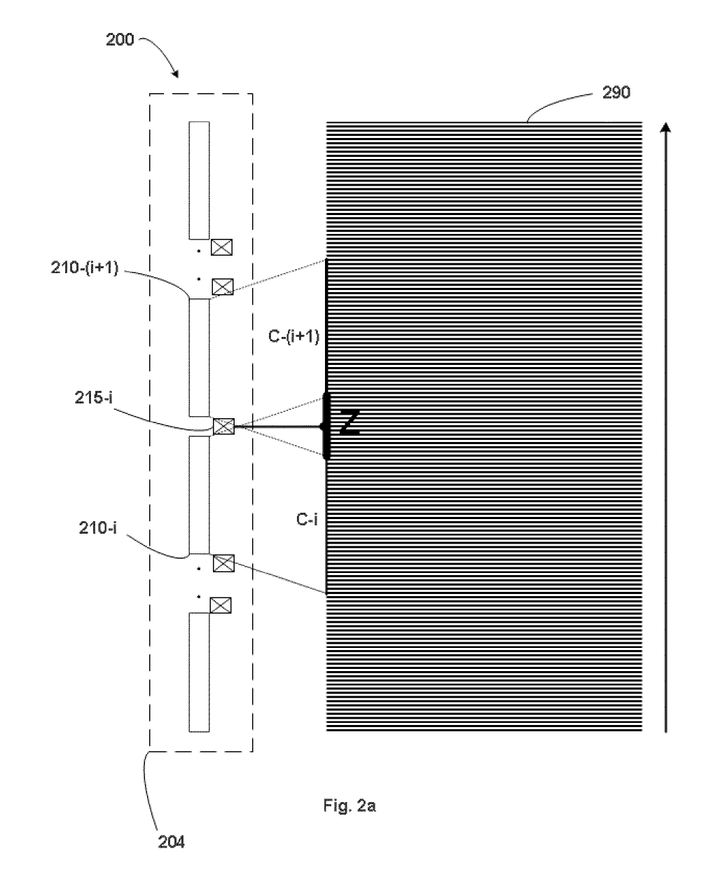

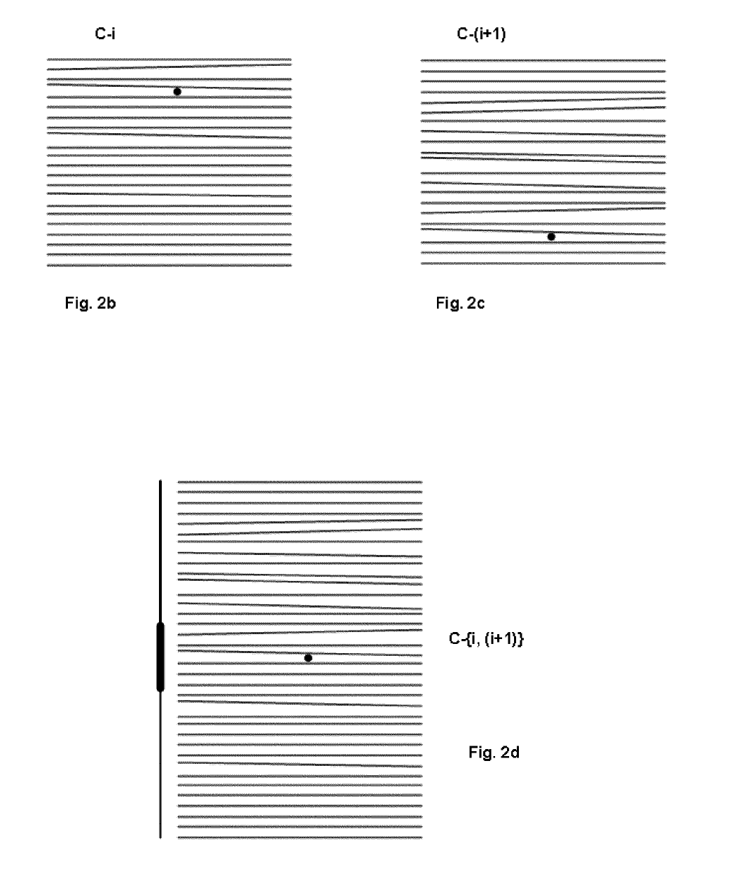

FIG. 2 schematically illustrates an image capturing phase of a device for counting planar substrates according to an example;

FIGS. 2a to 2d schematically illustrate an image matching phase of a device for counting planar substrates according to an example;

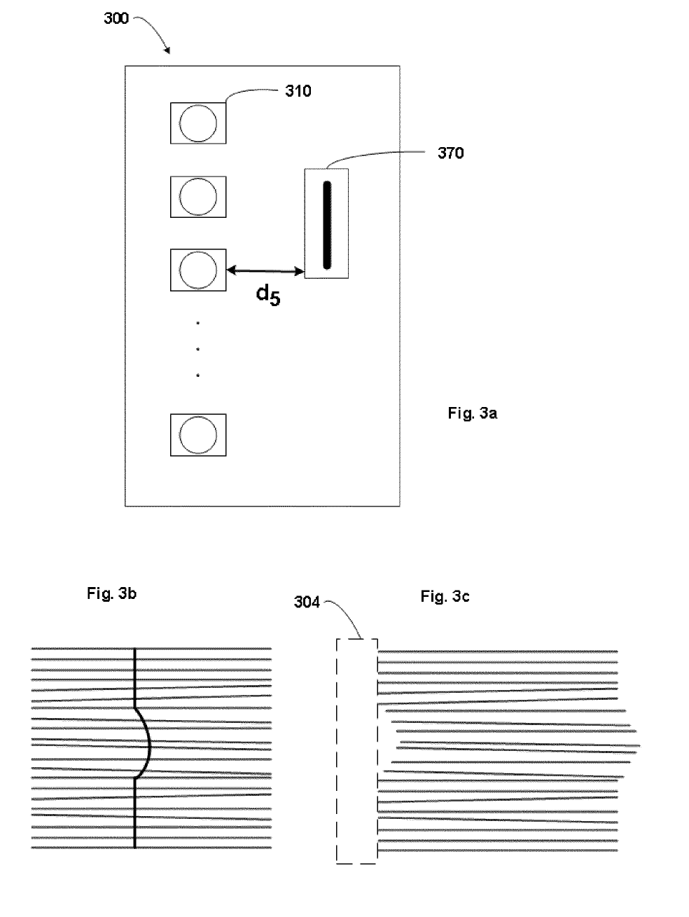

FIG. 3a illustrates a part of device for counting planar substrates with a laser line beamer, according to an example;

FIGS. 3b and 3c schematically illustrate a line beam on misaligned stacked planar substrates;

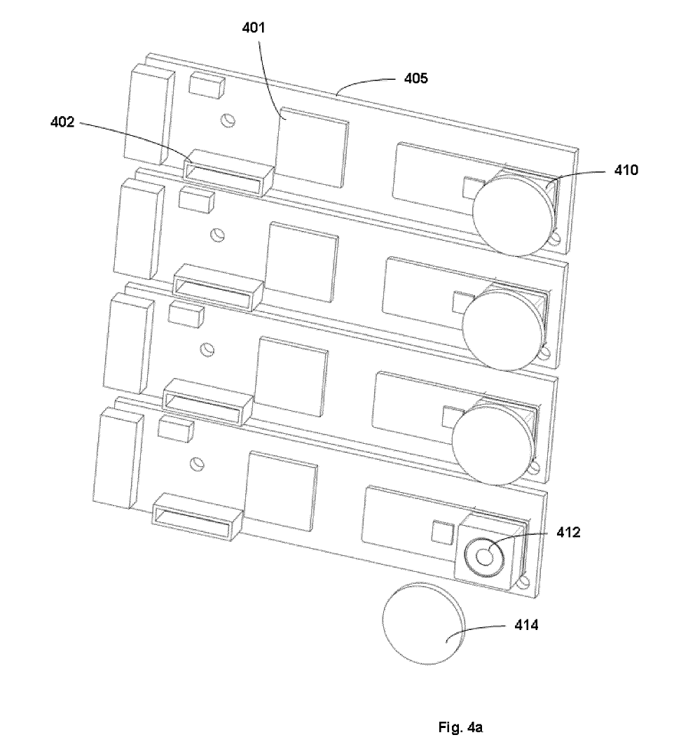

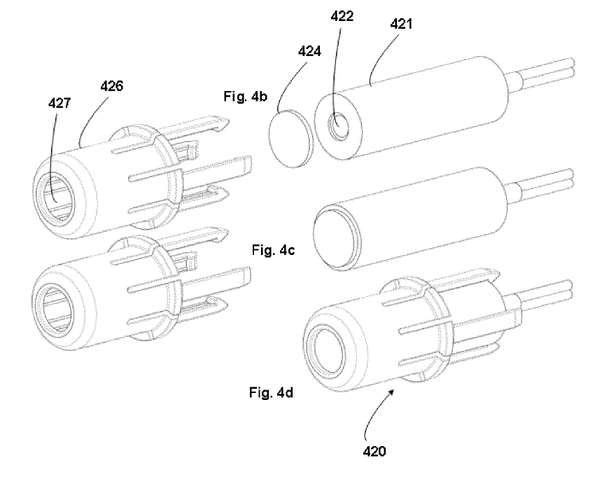

FIG. 4a illustrates a set of image capturing sensor modules, according to an example.

FIG. 4b-4d illustrate a multi-lens arrangement for a laser marking element, according to an example;

FIGS. 5a and 5b illustrate front and back views of a device for counting planar substrates, according to an example;

FIG. 5c illustrates an exploded view of a device for counting planar substrates, according to an example;

FIG. 5d illustrates a device for counting planar substrates with protective transparent flat element, according to an example;

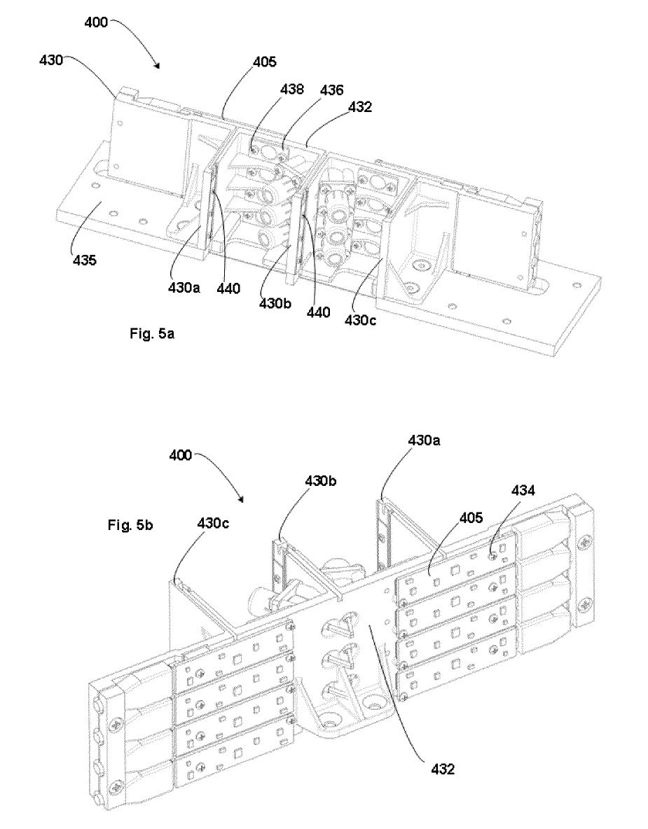

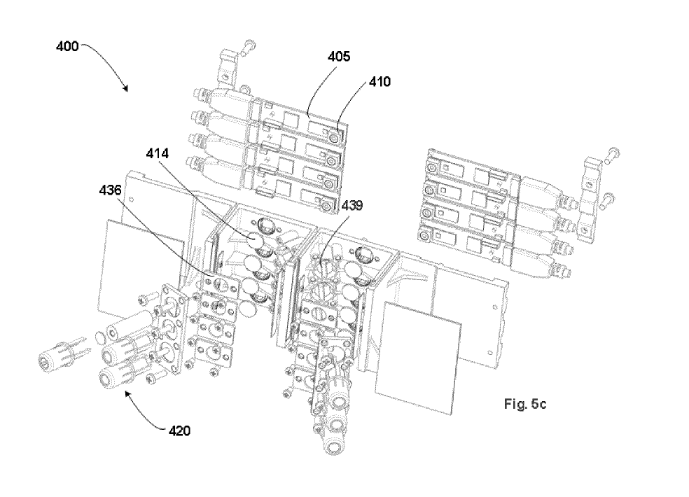

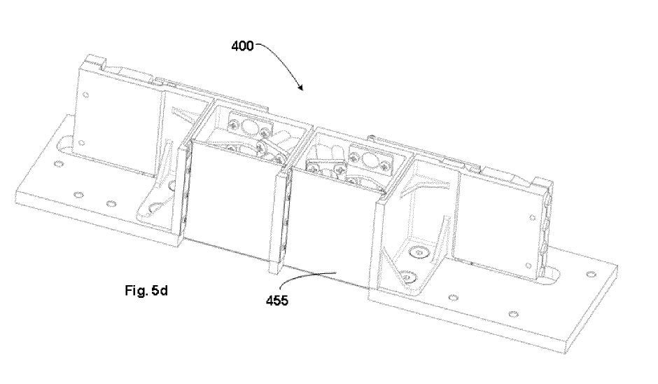

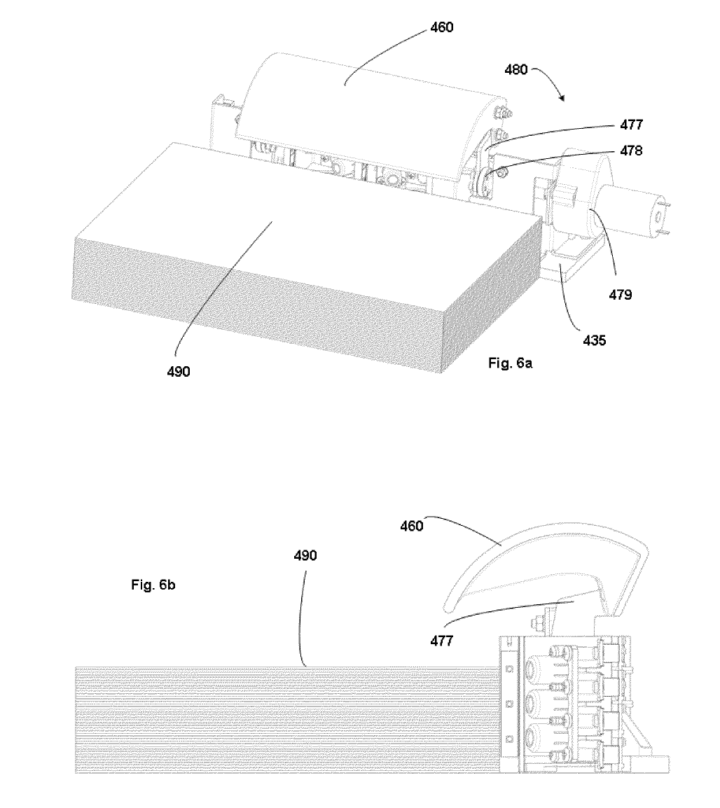

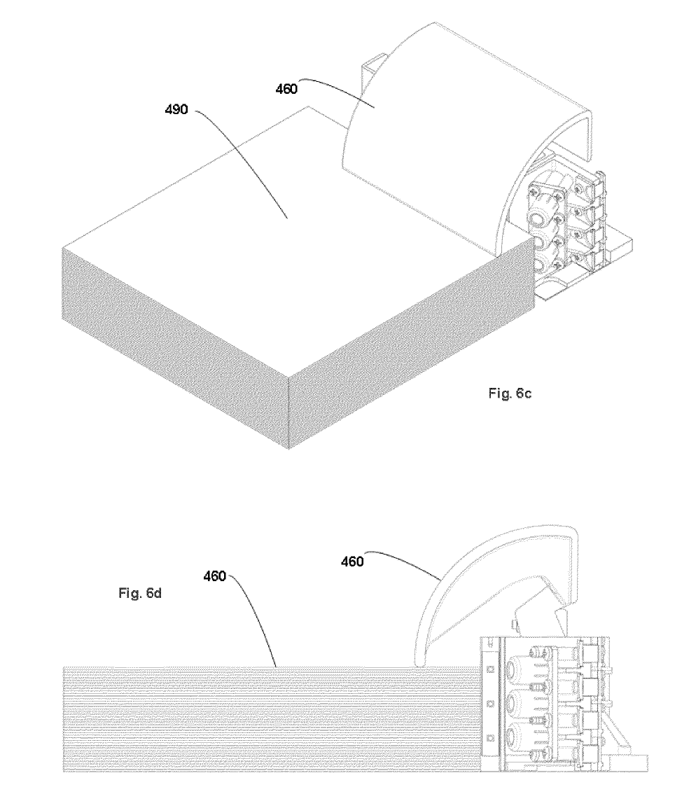

FIGS. 6a and 6b illustrate front and side views of a device for counting planar substrates with a moveable lid in stand-by position;

FIGS. 6c and 6d illustrate front and side views of a device for counting planar substrates with a moveable lid pressing against the stacked planar substrates;

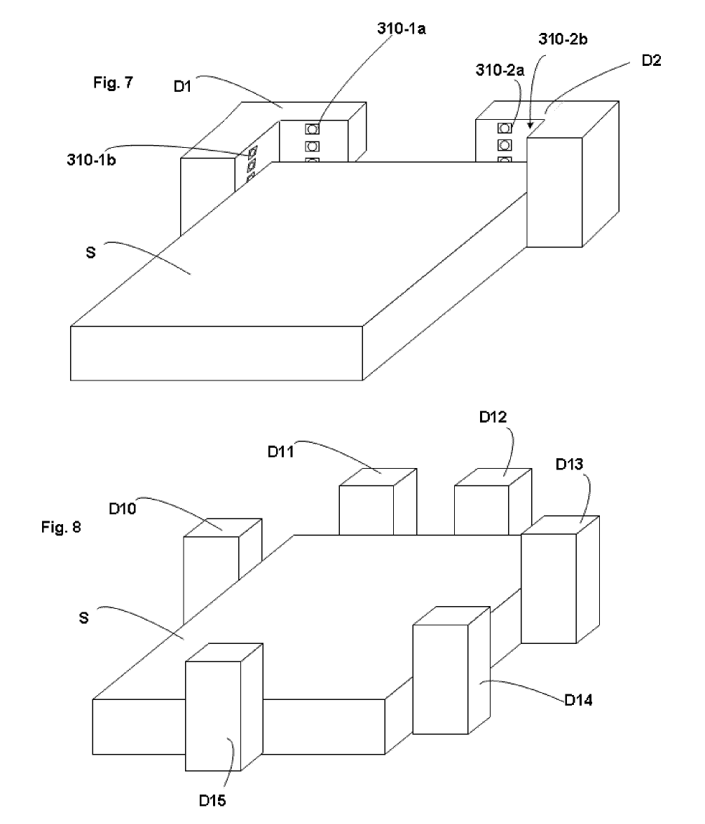

FIG. 7 illustrates an arrangement of multiple devices for counting planar substrates according to an example;

FIG. 8 illustrates another arrangement of multiple devices for counting planar substrates according to another example;

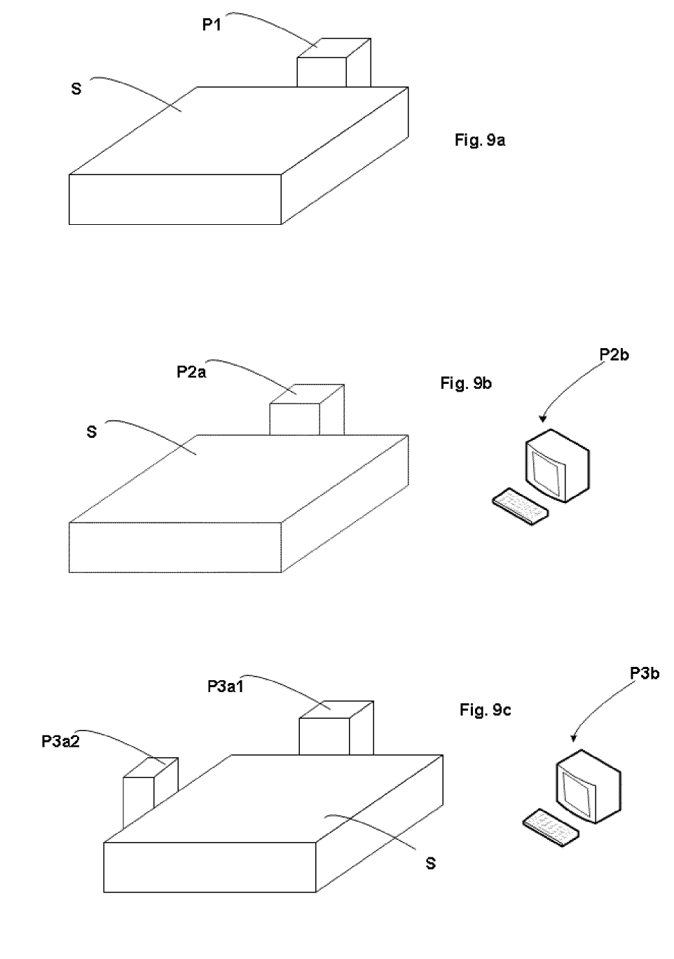

FIG. 9a illustrates an example device for counting planar substrates wherein a counting processing system is integrated in the device;

FIG. 9b illustrates an example wherein a counting processing system is distributed between a device for counting planar substrates and an external processing device;

FIG. 9c illustrates an example wherein a counting processing system is external to an arrangement for counting planar substrate;

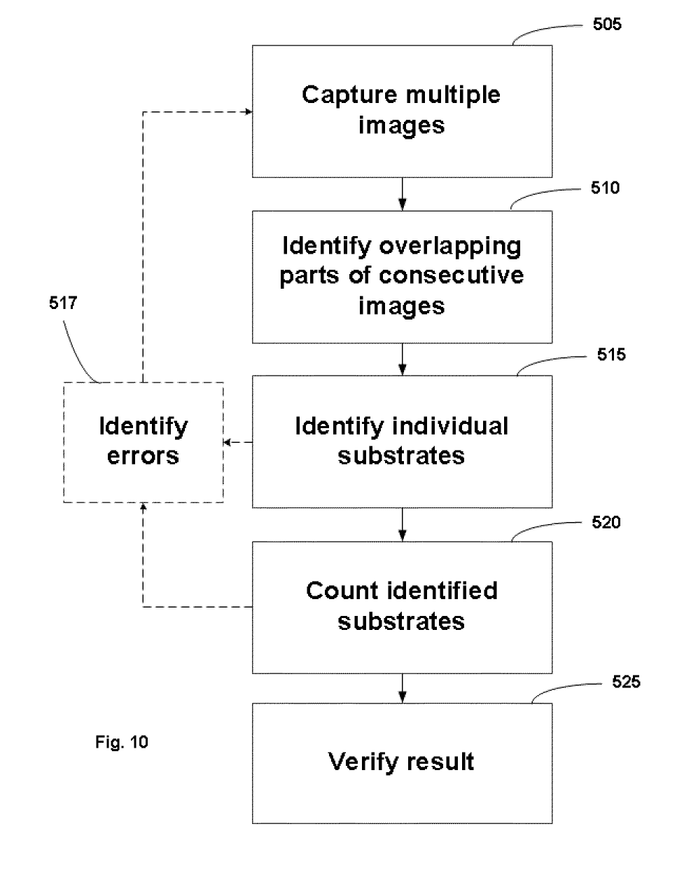

FIG. 10 is a flow chart of a method of counting stacked planar substrates, according to an example.

### DETAILED DESCRIPTION

FIGS. 1a and 1b illustrate image capturing sensors arranged collinearly along the same plane, according to example implementations. FIG. 1a illustrates a device 100A having multiple image capturing sensors (10-1 to 10-n) arranged collinearly on a frame 20. Each image capturing sensor comprises a light-sensitive element, such as an electronic sensor or a photographic film, and a lens element (11-1 to 11-n) to focus the image on the corresponding light-sensitive element. The lens element may be a single lens or a plurality of lenses arranges consecutively to enhance the focus of the image. FIG. 1b illustrates a device 100B having multiple frames 20-1 to 20-n arranged collinearly along the same plane. Each frame comprises an image capturing sensor. The frames 20-1 to 20-n may be arranged so that the image capturing sensors are substantially collinear with each other. Each image capturing sensor may capture an image that includes a portion of a stack of planar substrates. Any two images captured by consecutive sensors, e.g. 10-1 and 10-2, may comprise a common portion, i.e. a portion of the stack that appears in both images. By merging the images it is possible to reconstruct the whole stack with an adequate level of analysis to identify the single substrates and count the whole stack.

FIG. 1c illustrates image capturing sensors arranged in parallel columns, according to an example implementation. Device 100C may comprise a frame 30. A first set of image capturing sensors 100-11 to 100-n1 may be arranged in a first column and a second set of image capturing sensors 100-12 to 100-n2 may be arranged in a second column, respectively. The second column may be on the same plane as the first column or on another plane. Each set may capture images along a different line of a stack of planar substrates. The substrates may be identified separately for each set of images. It is thus possible to identify errors, e.g. folded or misaligned substrates, that may appear only in one of the sets of images. Accordingly, a counting process may take place for each set of images. By comparing the results of each counting process it may be possible to increase the accuracy of the counting process.

FIG. 1d illustrates image capturing sensors arranged in an array on the same plane, according to an example implementation. Image capturing sensors 100-11 to 100-nm are arranged in collinear columns and rows on a frame 120. Each column of sensors may be arranged to capture images along a different line of the same stack of planar elements. Then the images may be merged to form a single extended image. The planar substrates may subsequently be identified and counted from the single merged image. By generating a single extended image a wider area of the stack may be inspected. Consequently it may be easier to identify errors during the substrate identification process or during the counting process and thus achieve a counting result with a higher degree of certainty. The errors may be partially or fully folded substrates or an incorrect placement or misalignment of a substrate in the stack.

FIG. 2 schematically illustrates an image capturing phase of a device for counting planar substrates according to an example. A stack of planar substrates 290 may be placed in front of the image capturing sensors 210 of device 200. The image capturing sensors 210 may be arranged on a frame 204. The stack may have a height H. The stack 290 and the lens elements 214 of the image capturing sensors 210 may define a first distance d1. Two centers of consecutive image capturing sensors may define a second distance d2. The focused part of the captured image of each image capturing sensor may be defined as d3. The overlapping portion of two consecutive images may define a distance d4.

The required detail level of the image may be given by the minimum thickness of individual substrates in the stack and the minimum thickness of gaps (the space) between two adjacent substrates, which need to be greater or equal to the pixel size of the image in order to distinguish between two adjacent substrates and the gaps between them in the captured image. Therefore, the thinner the substrates, the higher the required detail level. A higher detail level may be obtained by decreasing the distance d1.

Moreover, the following relations can be established:
(i) d2<d3, i.e. the focused part of the image needs to be wider than the size of d2 which is the sensor or frame size plus the space between the consecutive sensors or frames, so that an overlapping area may exist.
(ii) d4>0, i.e. the overlapping area needs to be defined in the focused part of the image)

If an increased detail level is required, the distance d1 may need to decrease. As a result d3 may decrease and consequently d2 may need to decrease too in order to have a non-negative overlapping distance d4. Reducing d2 may imply having a smaller gap between the sensors or frames, or, if further size decrement is required, smaller sensors or frames.

The device 200 may further comprise a base 202 and a moveable lid 260. The moveable lid may be coupled to the frame 204. It may be used to press against the top substrate of the stack 290. This may allow a more uniform distribution of the substrates to facilitate their identification. Furthermore, it may reduce the ambient light that reaches the image capturing sensors that may hinder the substrate identification process. The interior of the moveable lid 260 may be colored or patterned so that the topmost substrate may be easily defined. Accordingly, the base 202 may be colored or patterned so that the bottommost substrate may be easily defined.

s FIGS. 2a to 2d schematically illustrate an image matching phase of a device for counting planar substrates according to an example.

In order to join two adjacent images accurately some reference projected or marked on the stack may be required. Any reference that is not marked on the stack may make the image merging precision to decrease significantly, as it may be highly susceptible to different perspectives of the image due to errors in positioning or alignment between the image capturing sensors and the stack of planar substrates.

In one implementation, a laser module may project a reference mark directly on the stack. In the example of FIG. 2a point lasers are used. In this example, the number of lasers is n−1 and the number of image capturing sensors is n arranged on a frame 204 of device 200. This is because n images may be captured along a line of stacked planar substrates and between the n images there may be n−1 overlapping portions. Therefore, the marking elements may only indicate the n−1 overlapping portions. For that reason, each marking element may be placed so that its center, i.e. the pointing direction of the laser beam, lies substantially on a plane coinciding with a plane passing at the border between two image capturing sensors. However, in other implementations, the capturing modules may be placed at other positions provided that the laser beam is pointing at the overlapping portion of the stacked planar substrates.

The image capturing sensor 210-i may capture an image C−i and the image capturing sensor 210-(i+1) may capture an image C-(i+1), respectively, of a portion of the stack 290. The overlap region Z indicated in the image may form part of both images. The i-th marking element may indicate the zone in both images with a beam projecting a mark at the overlapping zone of the stack. It may thus be possible to merge the two images into one by matching the overlap region with the help of the marking point of the beam on the substrates.

FIGS. 2b, 2c and 2d illustrate how the images captured by the image capturing sensors 210-(i) and 210-(i+1) would be used to form the merged image C-{i, i+1}. FIG. 2b shows the image C−i captured by i-th sensor. The marking point of the laser pointer may be seen at the upper part of the image. FIG. 2c shows the image C-(i+1) captured by (i+1)-th sensor. The marking point of the laser pointer may be seen at the lower part of the image. As both images contain the marking point it may be assumed that there is an overlapping zone Z between the images. By using the help of the marking point of the beam on the substrates, it may be possible to merge the two images into one by matching the overlap region. This is shown in FIG. 2d.

FIG. 3a illustrates a part of a device for counting planar substrates with a laser line beamer, according to an example. The device 300 may comprise collinear image capturing sensors 310 and a laser line beamer 370 arranged in parallel to the image capturing sensors 310. The laser line beamer may project a line beam towards the stack of planar substrates. The laser line beamer may be placed at a distance d5 from the image capturing sensors in order to project the line at an angle. The purpose of the laser line beamer is to indicate a misaligned stack of substrates that could generate errors during the counting process. A misaligned stack may be defined as a stack where the horizontal distance (d1 in FIG. 2) of its substrates from the sensors may not be constant for all the substrates.

FIG. 3b schematically illustrates a line beam on misaligned stacked planar substrates. FIG. 3b corresponds to the image as would be taken by the image capturing sensors. Without the line beam, it may not be possible to distinguish between aligned and misaligned substrates. However, the line laser may project a line perpendicularly to the substrates and at a certain angle. A local deviation may be seen around the middle of the stack. FIG. 3c shows the stack from a side where the misalignment may be identified and corrected before the counting process may begin. The stack is shown placed against a partition 304 of the device 300. Some substrates are misaligned with respect to the rest and with respect to the partition 304. It is noted that the misalignment may also be detected with the use of an image capturing sensor viewing the stack from the point of view of FIG. 3c, i.e. from a side perpendicular to where the image capturing sensors are used to capture the counting side of the stack. Alternatively or additionally, 3D or stereoscopic cameras may be used in place of the line laser to generate a 3D representation of the stack where any misalignment may then be identified. In case of 3D or stereoscopic cameras, they may be placed either on the same plane as the image capturing sensors 310 or on another plane.

FIG. 4a illustrates an example implementation of image capturing sensor modules arranged along the same plane. Each image capturing sensor module 405 comprises a rectangular frame. The rectangular frame may host an image capturing sensor 410, a power supply port 402 and a processing element 401. The module's 405 size and shape allows for the image capturing sensor 410 and any other electronic elements to be mounted on it and also allows for various modules to be collocated on the same plane so that the image capturing sensors 410 to be collinearly aligned. Each image capturing sensor may comprise a light-sensitive element 412 and a lens element 414. In the example of FIG. 4a, the lens element 414 comprises a single lens. However, in other implementations the lens element may comprise a plurality of lenses arranged consecutively to enhance the captured image.

FIGS. 4b to 4d illustrate a multi-lens arrangement for a laser marking element, according to an example. The laser marking element 420 may comprise a laser module 421, a secondary focusing lens 424 and a jacket element 426. The laser module 421 may comprise a body, housing the laser beam generating electronics, and a primary focusing lens 422 placed at the firing hole of the laser module 421. The jacket element 426 may comprise a jacket and a window 427. FIG. 4b is an exploded view of the parts of the multi-lens laser marking element. FIG. 4c illustrates the secondary focusing lens 424 placed on top of the primary focusing lens 422. FIG. 4d illustrates the jacket element 426 housing the laser module 421 so that the two focusing lenses 422 and 424 may form a composite lens element to enhance the beam generated by the laser module 421.

FIGS. 5a and 5b illustrate front and back views of a device for counting planar substrates, according to an example. FIG. 5c illustrates an exploded view of the device. The device 400 may comprise a casing 430. The casing may be fixed on a base 435 and may comprise a wall 432, perpendicular to the base and partitions 430a-430c, extending vertically from one side (“front side”) of the wall. In the example of FIGS. 5a and 5b, the casing comprises 3 partitions, 430a, 430b and 430c. Image capturing sensor modules 405 may be fixed on the other side of the wall (“back side”). The casing may comprise sensor openings so that the image capturing sensors 410 of the image capturing sensor modules 405 may protrude from the sensor openings of the casing to capture images from the front side of the wall. In the example of FIGS. 5a and 5b, the image capturing sensors 410 form two sets of image capturing sensors. Each set of image capturing sensors may be arranged collinearly to capture images along a line. The casing may further host marking elements 420. Between partitions 430a and 430b, the casing may host a first set of image capturing sensors 410 and a first set of marking elements 420. Accordingly, between partitions 430b and 430c the casing may host a second set of image capturing sensors 410 and a second set of marking elements 420. The image capturing sensor modules 405 may be fixed on the back side of the wall 432 with screws 434. The image capturing sensors 410 may be fixed from the front side of the wall with flanges 436 that may be screwed to the wall with screws 438. The flanges 436 may comprise an opening for allowing light to reach the light-sensitive elements of the image capturing sensors 410. The flanges may further serve as fixtures for additional focusing lenses 414 for the lens element of the image capturing sensors 410. This is better illustrated in FIG. 4c. Now, the marking elements 420 may be laser marking elements. Each marking element 420 may be fixed to the casing with screws so that the marking beam, e.g. the laser beam, may point at the stacked planar substrates at an angle in order to not distort the captured image. The marking elements may be fixed partly on the wall and partly on a partition in order to point at an angle. In the example illustrated, a first set of marking elements may be fixed between partition 430b and the part of the wall 432 that extends between partition 430a and 430b and a second set of marking elements may be fixed between partition 430b and the part of the wall 432 that extends between partition 430b and 430c. The first set of marking elements 420 may point at an angle towards the opening between partitions 430a and 430b. The second set of marking elements 420 may point at an angle towards the opening between partitions 430b and 430c. Each marking element may comprise a laser module 421, a secondary focusing lens 424 and a jacket element 426. The casing 430 may comprise sockets 439 to host the laser modules 420 and to provide power to the laser modules 420.

In the example of FIGS. 5a, 5b and 5c each set of image capturing sensor modules comprises four image capturing sensor modules. Furthermore, there are three marking elements 420 for each set of four image capturing sensor modules.

The device 400 may further comprise light emitting modules 440 to illuminate the stacked planar substrates. A first light emitting module may be arranged along the edge of partition 430a in a direction perpendicular to the base 435. A second light emitting module may be arranged along the edge of partition 430b, accordingly. Each light emitting module may comprise a number of light emitting elements, e.g. LEDs, fluorescent illumination, or any other type of illumination.

During a counting process, a stack of planar substrates, e.g. a stack of banknotes, may be placed in front of the device 400, i.e. against the edges of the partitions 430a-430c. The plane of the substrates may be perpendicular to the wall 432 and to the partitions 430a-430c.

The device 400 is configured to capture two sets of images of two areas of the stack. In other implementations, the device may comprise only one set of image capturing sensors and capture only one set of images. In yet other implementations 3 or more sets of image capturing modules may be used to capture 3 or more sets of images. Furthermore, although four image capturing sensors are illustrated, other implementations with less or more image capturing sensors are possible. The selection of the number of sensor may depend on the thickness of the substrates, the thickness (size) of the stack and/or the number of substrates in the stack. The device may further be extensible. That is, the casing may be expandable so that more image capturing sensor modules to be connectable to the casing. For example, in one implementation two or more casings may be connectable one on top of the other to provide the expandability.

FIG. 5d illustrates a device for counting planar substrates with a protective transparent element 455, according to an example. The partitions may each comprise a slot, parallel to the edge of the partitions and next to the light emitting modules. The slots may receive the protective transparent elements 455. The purpose of the protective transparent elements 455 is to protect the sensitive elements of the device, e.g. the image capturing sensors or the marking elements, from coming in contact with the stacked planar substrates while at the same time it may permit the images to be captured and the marking beams to be pointing at the overlapping portions of the substrates. The protective transparent elements 455 may be removable so they can be easily cleaned or replaced, if required.

FIGS. 6a and 6b illustrate front and side views of a device for counting planar substrates with a moveable lid 460 in repose stand-by position. FIGS. 6c and 6d illustrate front and side views of a device for counting planar substrates with the moveable lid 460 pressing against stacked planar substrates 490. The device, in its other characteristics, may be similar to the devices discussed above. The lid may be moveable between a stand-by position and a pressing position. A rotation mechanism 480 may be coupled to the moveable lid to rotate the lid between the repose position and the pressing position. The rotation mechanism 480 may comprise an arm 477, fixedly attached to the lid at one end, and a rotatable element, such as a disc 478, fixedly attached to the other end of the arm 477. An actuator 479, either manual or electric, may rotate the rotatable element and consequently the lid between the two positions. The rotation mechanism may be attached to the casing or it may be attached to the base 435 of the device.

FIG. 7 illustrates an arrangement of multiple devices for counting planar substrates according to an example. A first device D1 may be placed at a first corner of a stack of planar substrates S. It may comprise two sets of image capturing sensors. A first set of image capturing sensors 310-1a may capture images along a first plane of the stack. A second set of image capturing sensors 310-1b may capture images along a second plane of the stack. A second device D2 may be placed at a second corner of the stack of planar substrates. It may also comprise two sets of image capturing sensors. A third set of image capturing sensors 310-2a may capture images along the first plane of the stack. A fourth set of image capturing sensors 310-2b (not visible) may capture images along a third plane of the stack, parallel to the second plane.

FIG. 8 illustrates another arrangement of multiple devices for counting planar substrates according to another example. Devices D10-D15 are arranged around the stack of planar substrates S. Devices D10 and D11 may capture images along a first plane of the stack, devices D12 and D13 may capture images along a second plane of the stack, device D14 may capture images along a third plane of the stack, parallel to the first plane, and, finally, device D15 may capture images along a fourth plane of the stack, parallel to the second plane.

In the examples arrangements of FIGS. 7 and 8, the stack of planar substrates may be manually or automatically placed in a counting position. Alternatively, the devices may be moveable, manually or automatically in order to be placed against the corners or sides of the stack S.

Once the images are captured, they may be processed so that any counting algorithms to be performed on the processed images. The processing may be local to the image capturing device, remote or distributed. FIG. 9a illustrates an example device for counting planar substrates wherein a counting processing system is integrated in the device P1. The image capturing device may contain a processing unit integrated in the device. The processing unit may be programmed to configure the parameters of the image capturing device and also the information received from the image capturing sensors, i.e. merge the images and perform counting algorithms. The result of the processing may be the number of substrates in a stack of planar substrates S.

FIG. 9b illustrates an example wherein a counting processing system is distributed between a device P2a for counting planar substrates and an external processing device P2b. The image capturing device P2a may be connected with a cable or wirelessly to the external processing device. For example, the image capturing device P2a may be programmed to capture the images and transmit them to the external processing device P2b. The external processing device P2b may be programmed to receive the images and perform the image merging and the counting algorithms. Alternatively, the image capturing device after performing the image capturing may perform part or all of the rest of the processes required, e.g. image combining, counting, error identification and the external processing device may perform the rest and/or validate the result.

FIG. 9c illustrates an example wherein a counting processing system is external to an arrangement for counting planar substrate. The arrangement may comprise image capturing devices P3a1 and P3a2. Each device may transmit the raw images or the merged processed images to the external processing system P3b. The external processing system P3b may then perform the merging and counting algorithms, as required, based on the information received from the various image capturing devices.

In the above mentioned example arrangements, a master-slave implementation may also be possible. That is, an image capturing device may act as a server (master) that may collect the images or the results from the other image capturing devices (slaves or clients) and perform counting algorithms or validation algorithms, i.e. algorithms for comparing the results the acquired by the client devices.

FIG. 10 illustrates a method of counting stacked planar substrates according to an example. In a first step 505, multiple images of the stacked planar substrates may be captured along a plane. The step may comprise capturing sets of multiple images at different areas of the stack on the same plane or at different planes. Then, in step 510, the overlapping parts of consecutive captured images may be identified. In some cases, marking spots, e.g. laser spots on consecutive (adjacent) images may be used as points of reference to identify the overlapping parts. In other cases, e.g. when the size of the laser spots coincides with more than one piece of analyzed substrates, the coordinates of the centers of the laser spots detected on adjacent images may be used to select the position of larger areas of the image, which may be utilized as templates to match the overlapping areas. A template matching algorithm may then be applied in order to find the position of best correlation between the two areas. This position may be used to calculate a frontier substrate. In step 515, the individual substrates may be identified. During the identification step it may be possible to digitally process the images, e.g. perform edge enhancement filters, to facilitate the identification of individual substrates and detect errors. If an error is identified in 517, then the process may be restarted in 505. In step 520 the identified substrates may be counted. Again, if an error is detected after counting then the process may need to be restarted. The identification may be implemented on the individual captured images and, taking into consideration the identified overlapping part, make sure that each substrate is counted only once. Alternatively, the captured images may be combined to generate a composite image and each substrate may be identified on the composite image. Counting algorithms may thus be applied either to the individual images or to the output composite image. Finally, in step 525, the results may be validated. For example, if various counts are performed, e.g. at different areas of the stack, then the results may be compared. If they coincide the count may be validated. Otherwise, a majority vote may determine the correct result or the process may need to be repeated.

Although only a number of particular embodiments and examples have been disclosed herein, it will be understood by those skilled in the art that other alternative embodiments and/or uses and obvious modifications and equivalents thereof are possible. Furthermore, the disclosure covers all possible combinations of the particular embodiments described. Thus, the scope of the disclosure should not be limited by particular embodiments.

Further, although the examples described with reference to the drawings comprise computing apparatus/systems and processes performed in computing apparatus/systems, the disclosure also extends to computer programs, particularly computer programs on or in a carrier, adapted for putting the system into practice.

1. A device for counting planar substrates stacked on a first plane, comprising:
image capturing sensors arranged collinearly, substantially perpendicularly to the first plane, each image capturing sensor being configured to capture an image of a portion of a counting side of the stacked planar substrates, the image capturing sensors being coupled to a preprocessing module for preprocessing the captured images and to identify errors in the counting of the stacked planar substrates,
wherein the image capturing sensors are configured so that images captured by every two consecutive image capturing sensors comprise an overlapping portion of the stacked planar substrates.

2. The device according to claim 1, wherein the image capturing sensors are arranged along a frame, the frame being arranged perpendicularly to the first plane.

3.-6. (canceled)

7. The device according to claim 1, wherein each image capturing sensor comprises one or more lens elements and an electronic sensor, wherein the one or more lens elements are configured to capture light from the portion of the counting side of the stacked planar substrates and bring the light to a focus on the electronic sensor.

8. (canceled)

9. The device according to claim 1, further comprising one or more marking elements configured to indicate the overlapping portion on the captured images.

10.-21. (canceled)

22. The device according to claim 1, further comprising an alignment detector configured to indicate an alignment of the stacked planar substrates.

23.-29. (canceled)

30. The device according to claim 1, wherein the preprocessing module is configured to receive the images and apply image recognition algorithms to the images to recognize each substrate of the stack.

31. The device according to claim 1, further comprising a counting processing system for receiving the preprocessed images and counting the stacked planar substrates based on the preprocessed images.

32. The device according to claim 31, wherein the preprocessing module is configured to receive the images and apply image recognition algorithms to the images to recognize each substrate of the stack, and wherein the counting processing system is configured to implement counting algorithms to count the recognized substrates.

33.-34. (canceled)

35. The device according to claim 1, wherein the stacked planar substrates are stacks of security documents, stacks of sheets of security documents or stacks of substrate sheets used in the production of security documents.

36.-40. (canceled)

41. A method of counting planar substrates stacked on a first plane, comprising:
capturing multiple images of the stacked planar substrates, the multiple images containing a complete counting side of the stacked planar substrates, wherein each image contains a portion of the complete counting side, wherein any two consecutive images captured comprise an overlapping part of the complete counting side;
preprocessing the captured images;
identifying the overlapping parts of each of the two consecutive captured images;
identifying each individual substrate;
counting the identified individual substrates; and
identifying errors in the counting of the identified individual substrates.

42. The method according to claim 41, further comprising identifying each individual substrate in each captured image and counting each substrate only once based on the identification of the overlapping parts.

43.-45. (canceled)

46. The method according to claim 41, further comprising identifying errors in a placement of the stack.

47. (canceled)

48. The method according to claim 41, wherein the identifying each individual substrate comprises identifying each substrate with a certainty above a predetermined threshold.

49.-50. (canceled)

51. Non-transitory computer readable medium storing a program that causes a computer to:
capture multiple images of stacked planar substrates, the multiple images containing a complete counting side of the stacked planar substrates, wherein each image contains a portion of the counting side, and wherein any two consecutive images captured comprise an overlapping part of the counting side of the stacked planar substrates;
preprocess the captured images;
identify the overlapping parts of the two consecutive captured images;
identify each individual substrate of the stacked planar substrates;
count the identified individual substrates; and
identify errors in the counting of the identified individual substrates.

52. The method according to claim 41, further comprising using a marking element to indicate the overlapping portion on the captured images.

53. A device for counting planar substrates stacked on a first plane, comprising:
one or more image capturing sensors arranged substantially perpendicularly to the first plane, the one or more image capturing sensors being configured to capture images of a counting side of the stacked planar substrates,
a preprocessing module coupled to the one or more image capturing sensors, the preprocessing module being configured to receive and preprocess the captured images and to identify individual substrates in the counting of the stacked planar substrates.

54. The device according to claim 53, the preprocessing module further being configured to identify errors in a placement of the substrates.

55. The device according to claim 53, further comprising a counting processing system configured to implement counting algorithms to count the identified individual substrates.

56. The device according to claim 55, the counting processing system further being configured to implement counting algorithms to identify errors in the counting of the stacked planar substrates.

57. The device according to claim 53, further comprising one or more marking elements configured to indicate an overlapping portion on the captured images.
